(19) United States
(12) Patent Application Publication
(10) Pub. No.: US 2026/0175432 A1
(43) Pub. Date: Jun. 25, 2026

(54) SYSTEM AND METHOD FOR ASSEMBLING VEHICLE COMPONENT TO VEHICLE BODY

(71) Applicant: Ford Global Technologies, LLC, Dearborn, MI (US)

(72) Inventors: Jon Arthur Zimmerman, Ferndale, MI (US); Kurt Michael Lundeen, Novi, MI (US); Jacqueline Kotenko, Washington, MI (US)

(73) Assignee: Ford Global Technologies, LLC, Dearborn, MI (US)

(21) Appl. No.: 18/989,794

(22) Filed: Dec. 20, 2024

(51) Int. Cl. B25J 9/16; B62D 65/14

(52) U.S. Cl. CPC B25J 9/1687; B25J 9/1682; B62D 65/14

(57) ABSTRACT

A system for assembling a vehicle component to a vehicle body includes at least one robot and a controller. The controller is in communication with the robot. The controller configured to instruct the robot to guide a first portion of a seat belt through an opening in a first component of the vehicle component, instruct the robot to couple the first component to the vehicle body, instruct the robot to insert a second portion of the seat belt into a slit in a second component of the vehicle component, and instruct the robot to couple the second component to the vehicle body.

### FIELD

The present disclosure relates to a system and method for assembly a vehicle component to a vehicle body.

### BACKGROUND

The statements in this section merely provide background information related to the present disclosure and may not constitute prior art.

Industrial robots have been used for a variety of manufacturing operations, including by way of example, welding and moving parts from one location to another such as retrieving parts from a storage location and moving them to an assembly station. Automating the moving of some vehicle parts may be challenging because of the lack of proper handling of the part and mechanical repeatability.

These issues related to automating the handling of components, among other issues related to processing the components, are addressed by the present disclosure.

### SUMMARY

This section provides a general summary of the disclosure and is not a comprehensive disclosure of its full scope or all of its features.

In one form, the present disclosure provides a system for assembling a vehicle component to a vehicle body having a seat belt. The system includes at least one robot and a controller in communication with the robot. The controller is configured to instruct the robot to guide a first portion of the seat belt through an opening in a first component of the vehicle component, instruct the robot to couple the first component to the vehicle body, instruct the robot to move the second vehicle component in a predetermined pattern to guide a second portion of the seat belt into a slit in the second component of the vehicle component, instruct the robot to couple the second component to the vehicle body.

In variations of the system of the above paragraph, which can be implemented individually or in any combination: the at least one robot includes a first robot and a second robot, the first robot couples the first component and the second component to the vehicle body; the second robot guides the first portion of the seat belt through the opening in the first component; the second robot directs a webbing of the seat belt away from the vehicle body prior to the second component being coupled to the vehicle body; the first portion of the seat below is secured to the vehicle body after the first component is coupled to the vehicle body; and instructing the robot to guide the first portion of the seat belt through the opening in the first component comprises rotating the first portion of the seat belt.

In another form, the present disclosure provides a system for assembling a vehicle component to a vehicle body having a seat belt. The system includes first and second robots and a controller in communication with the first and second robots. The controller is configured to instruct the first robot to pick-up a first component of the vehicle component, instruct the second robot to guide a first portion of the seat belt through an opening in the first component, instruct the first robot to couple the first component to the vehicle body, instruct the first robot to pick-up a second component of the vehicle component, instruct the first robot to move the second vehicle component in a predetermined pattern to guide a second portion of the seat belt into a slit in the second component of the vehicle component, and instruct the first robot to couple the second component to the vehicle body.

In variations of the system of the above paragraph, which can be implemented individually or in any combination: the vehicle component is a vehicle pillar panel; the controller instructs the second robot to direct a webbing of the seat belt away from the vehicle body prior to the second component being coupled to the vehicle body; instructing the second robot to guide the first portion of the seat belt through the opening in the first component comprises rotating the first portion of the seat belt; the first portion of the seat belt is secured to the vehicle body after the first component is coupled to the vehicle body; the controller instructs the first robot to move the first component such that the first component receives the first portion of the seat belt in the opening prior to the second robot guiding the first portion of the seat belt through the opening in the first component; the first portion of the seat belt is removably coupled to the vehicle body prior to the first component receiving the first portion of the seat belt in the opening of the first component; and instructing the second robot to guide the first portion of the seat belt through the opening in the first component further includes guiding a buckle of the seat belt through the opening in the first component.

In yet another form, the present disclosure provides a method for assembling a vehicle component to a vehicle body having a seat belt. The method includes guiding a first portion of the seat belt through an opening in a first component of the vehicle component, coupling the first component to the vehicle body, inserting a second portion of the seat belt into a slit in a second component of the vehicle component, and coupling the second component to the vehicle body.

In variations of the method of the above paragraph, which can be implemented individually or in any combination: the first component and the second component are coupled to the vehicle body using a first robot, the first portion of the seat belt is guided through the opening using a second robot; the method further includes directing a webbing of the seat belt away from the vehicle body prior to the second component being coupled to the vehicle body; guiding the first portion of the seat belt through the opening in the first component comprises rotating the first portion of the seat belt; the method further includes securing the first portion of the seat belt to the vehicle body after the first component is coupled to the vehicle body; and guiding the first portion of the seat belt through the opening in the first component further includes guiding a buckle of the seat belt through the opening in the first component.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of a system for handling a vehicle component of a vehicle according to the principles of the present disclosure;

FIG. 2 is a perspective view of a vehicle body of the vehicle with the vehicle component installed therein;

FIG. 3 is perspective view of a pillar of the vehicle of FIG. 2 including a seat belt;

FIGS. 4A-4E are schematic views showing a first component of the vehicle component being coupled to the vehicle body of FIG. 2;

FIG. 5A is a perspective view of robots of the system of FIG. 1 regripping a portion of the seat belt;

FIG. 5B is a perspective view of one of the robots of the system of FIG. 1 coupling the portion of the seat belt to the vehicle body;

FIGS. 6A-6D are schematic views showing a second component of the vehicle component being coupled to the vehicle body of FIG. 2;

FIG. 7 is a schematic block diagram showing components of the system of FIG. 1 in accordance with the teachings of the present disclosure; and

FIG. 8 is a flowchart depicting an algorithm for handling the first component of the system of FIG. 1 in accordance with the teachings of the present disclosure; and

FIG. 9 is a flowchart depicting an algorithm for handling the second component of the system of FIG. 1 in accordance with the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

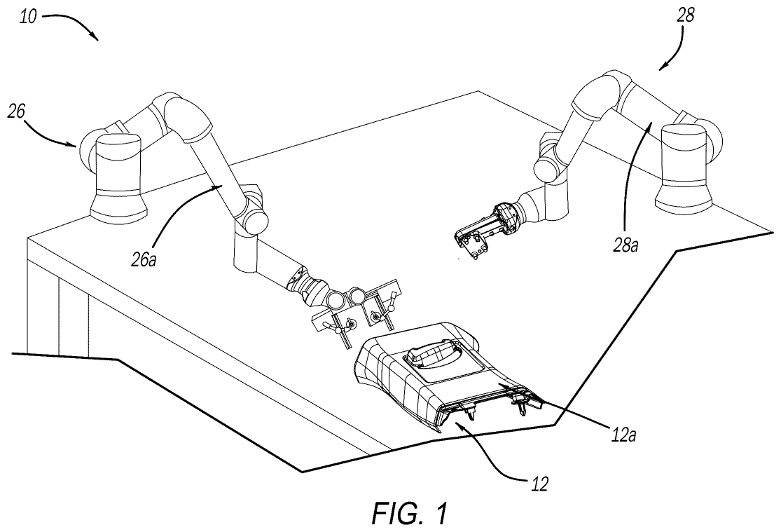

With reference to FIG. 1, a system 10 for handling one or more vehicle components 12 (only one shown in the figure) is illustrated. The handling of the vehicle components 12 may include retrieving the vehicle components 12 from a part support (e.g., a dunnage rack), manipulating parts of the vehicle components 12, and/or installing the vehicle components 12 into a vehicle 17. The system 10 allows for the handling of the vehicle components 12 with little to no human intervention. In this way, the handling of the vehicle components 12 may be automated to increase productivity, reduce cycle time, and reduce variation and error, for example. In the example illustrated, the vehicle components 12 may include vehicle pillar trim components such as B-pillar trim components. That is, vehicle pillar components may be challenging to automate due to grasping complex components, protecting surfaces and feeding components through tight spaces. The system 10 of the present disclosure provides for the adaptation of vehicle components 12 such as vehicle pillar components to better support automation. It should be understood that the vehicle components 12 may be other components of a vehicle other than vehicle pillar trim components.

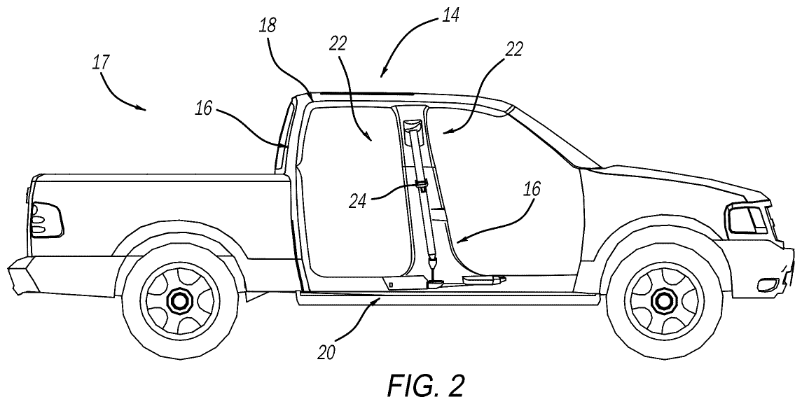

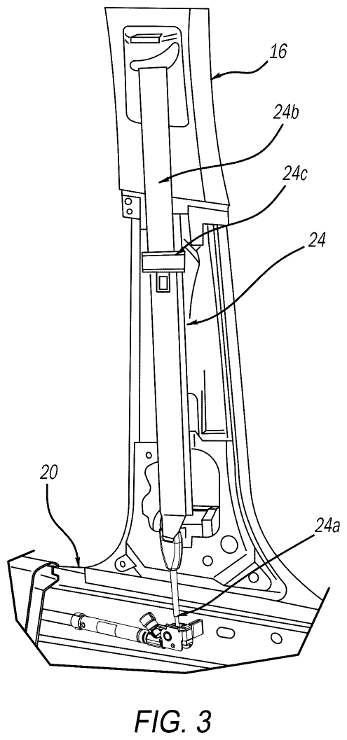

With reference to FIG. 2, the vehicle 17 includes a vehicle body structure 14 having a plurality of pillars 16, a pair of side rails 18 (only one shown in the figure), and rockers 20 (only one shown in the figure). The pillars 16, the rockers 20 and the side rails 18 cooperate to define door openings 22 in the vehicle body structure 14. Doors (not shown) are rotatably coupled to the vehicle body structure 14 between a closed position in which the doors are disposed within the door openings 22 and an open position in which the doors are removed from the door openings 22. With additional reference to FIG. 3, seat belts 24 (only one shown in the figures) are coupled to the vehicle 17 (e.g., a pillar 16 of the vehicle 17) and each may include, inter alia, a pretensioner 24a, a webbing 24b, and a tongue 24c. The pretensioner 24a may permit the webbing 24b to fit snug against the occupant's body. The tongue 24c is coupled to the webbing 24b and fits into a buckle (not shown) to secure the seat belt 24.

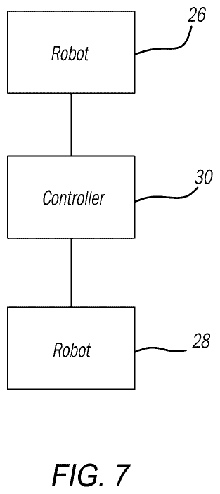

With reference back to FIGS. 1, the system 10 includes robots 26, 28, the vehicle component 12, and a controller 30 (FIG. 7). As will be described in more detail below, the robot 26 is configured to pick-up parts of the vehicle component 12, move parts of the vehicle component 12 from a work surface, for example, to the vehicle 17, manipulate (e.g., rotate) parts of the vehicle component 12 relative to the vehicle 17, and couple parts of the vehicle component 12 to the vehicle 17. The robot 26 includes a robot arm 26a and a robotic gripper structure or apparatus 26b. The robot arm 26a includes a plurality of segments connected to each other at joints, thereby allowing the robot 26 to have multiple degrees of freedom. The robot arm 26a is also secured to the work surface at a first end. In some variations, the robot arm 26a includes an optional adapter (not shown) that is adapted to be secured to the work surface. In some forms, the robot 26 is separate from the work surface and is partially or fully autonomous and is configured to autonomously move to the part support (not shown) and/or work surface as instructed by the controller 30. To autonomously move itself, the controller 30 is configured to control various movement systems of the robot 26 based on location data obtained from one or more sensors. In an example application, the movement systems may include propulsion systems, steering systems for controlling wheels, and the sensors for providing location data may include a GNSS sensor, an imaging sensor, a local position sensor, among others.

The robotic gripper structure 26b is secured to the robot arm 26a and is configured to pick-up the parts of the vehicle component 12. In this way, the robotic gripper structure 26b may grip the parts of the vehicle component 12 and move the parts from one location to another location as will be described in more detail below. The robotic gripper structure 26b may also manipulate the parts (e.g., rotate the parts) relative to the vehicle 17 to facilitate coupling the parts of the vehicle component 12 to the vehicle 17. One example of such robotic gripper structure 26b is disclosed in U.S. patent application Ser. No. XX/000,000, and titled “ROBOTIC GRIPPER APPARATUS FOR COUPLING TO VEHICLE COMPONENT,” which is commonly owned with the present application and the contents of which are incorporated herein by reference in its entirety.

The robot 28 is configured to pick-up parts of the seat belt 24, guide or direct parts of the seat belt 24 through the vehicle component 12, manipulate (e.g., rotates) parts of the seat belt 24 relative to the vehicle 17 and/or the vehicle component 12, and couple parts of the seat belt 24 to the vehicle 17. The robot 28 includes a robot arm 28a and a robotic gripper structure or apparatus 28b. The robot arm 28a includes a plurality of segments connected to each other at joints, thereby allowing the robot 28 to have multiple degrees of freedom. The robot arm 28a is also secured to the work surface at a first end. In some variations, the robot arm 28a includes an optional adapter (not shown) that is adapted to be secured to the work surface. In some forms, the robot 28 is separate from the work surface and is partially or fully autonomous and is configured to autonomously move to the part support (not shown) and/or work surface as instructed by the controller 30. To autonomously move itself, the controller 30 is configured to control various movement systems of the robot 28 based on location data obtained from one or more sensors. In an example application, the movement systems may include propulsion systems, steering systems for controlling wheels, and the sensors for providing location data may include a GNSS sensor, an imaging sensor, a local position sensor, among others.

The robotic gripper structure 28b is secured to the robot arm 28a and is configured to pick-up the parts of the seat belt 24. In this way, the robotic gripper structure 28b may grip the parts of the seat belt 24 and guide the parts through the vehicle component 12 as will be described in more detail below. The robotic gripper structure 28b may also manipulate the parts (e.g., rotate the parts) relative to the vehicle 17. One example of such robotic gripper structure 28b is disclosed in U.S. patent application Ser. No. XX/000,000, and titled “ROBOTIC GRIPPER APPARATUS FOR COUPLING TO VEHICLE COMPONENT,” which is commonly owned with the present application and the contents of which are incorporated herein by reference in its entirety.

With reference to FIG. 7, the controller 30 is in communication with the robots 26, 28 and may monitor and control operations of the robots 26, 28 based on data received. In one example, the controller 30 is in communication with the robots 26, 28 using a wired or wireless communication protocol (e.g., a Bluetooth®-type protocol, a cellular protocol, a wireless fidelity (Wi-Fi)-type protocol, a near-field communication (NFC) protocol, an ultra-wideband (UWB) protocol, among others).

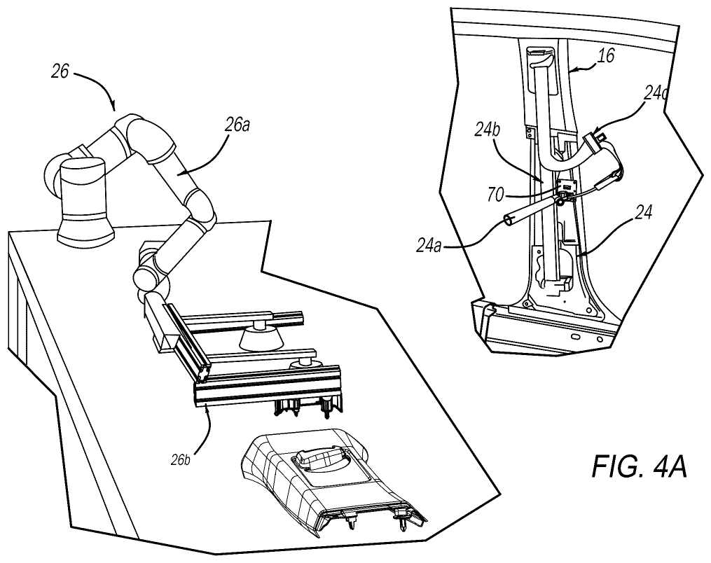

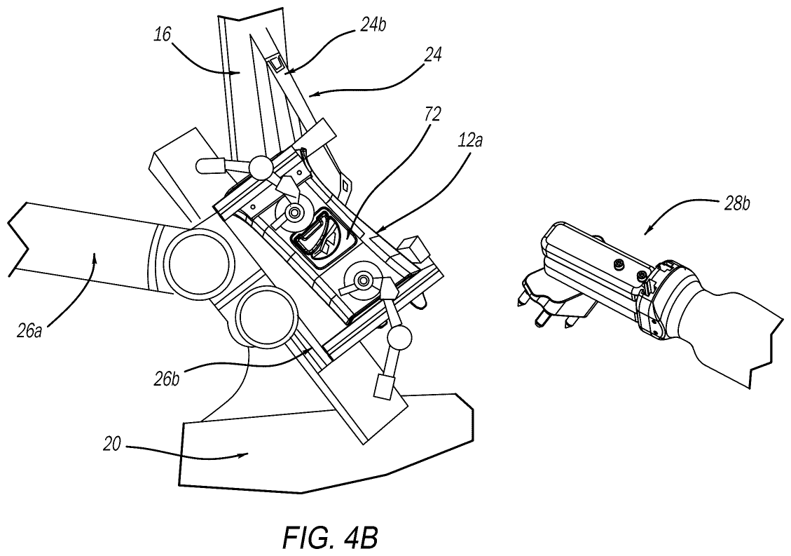

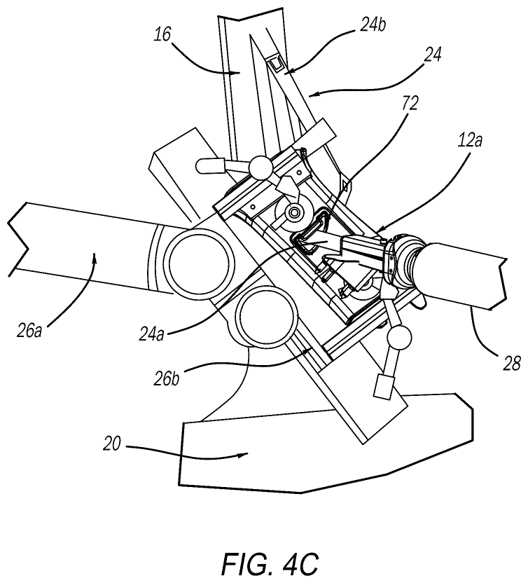

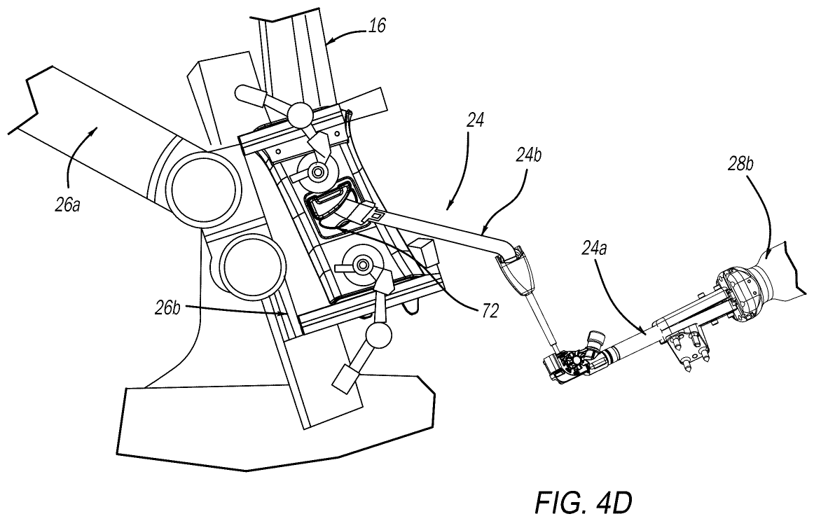

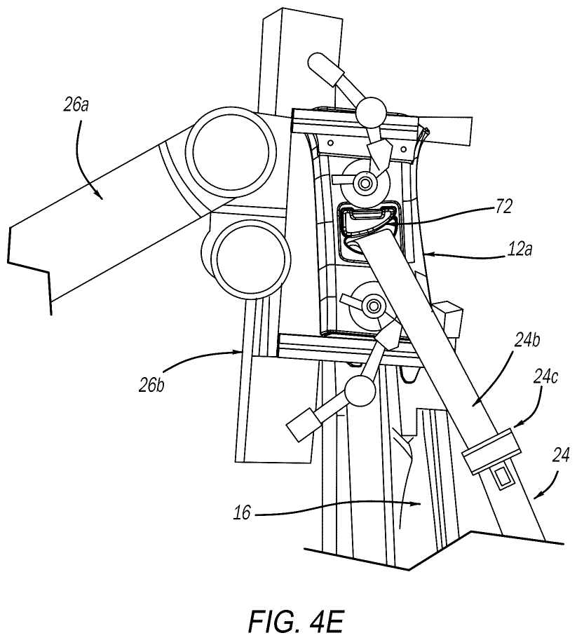

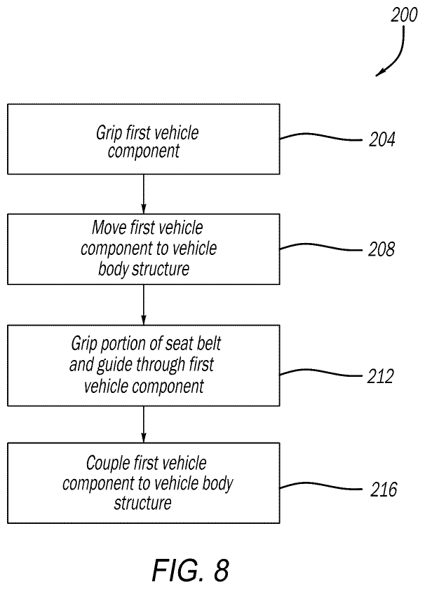

Referring to FIGS. 4A-4E and 8, an example control algorithm 200 for assembling a trim panel or first vehicle component 12a of the vehicle component 12 into the vehicle 17 is illustrated. The processing may begin once the first vehicle component 12a is moved from the part support (not shown) to the work surface and/or the vehicle body structure 14 arrives at a workstation where the first vehicle component 12a and the robots 26, 28 are located. At 204, the control algorithm, using the controller 30, instructs the robot 26 to grip or pick-up the first vehicle component 12a of the vehicle component 12 (FIG. 4A). The first vehicle component 12a may be located at a rack or storage area that inhibits movement of the first vehicle component 12a prior to being picked-up by the robot 26. At 208, the control algorithm, using the controller 30, instructs the robot 26 to move the first vehicle component 12a to the vehicle pillar 16 of the vehicle body structure 14 such that an opening 72 of the first vehicle component 12a receives a portion of the pretensioner 24a (FIG. 4B; i.e., the pretensioner 24a is received at least partially through the opening 72 of the first vehicle component 12a). In some forms, the robot 26 may move the first vehicle component 12a to the vehicle pillar 16 such that the pretensioner 24a is located at the opening 72 (e.g., aligned with the opening 72) of the first vehicle component 12a without being partially received in the opening 72 of the first vehicle component 12a.

At 212, the control algorithm, using the controller 30, instructs the robot 28 to grip the pretensioner 24a and guide the pretensioner 24a, the tongue 24c and a portion of the webbing 24b through the opening 72 of the first vehicle component 12a (FIGS. 4C and 4D). The robot 26 may move the first vehicle component 12a and/or the robot 28 may move (e.g., rotate) the pretensioner 24a to reposition the first vehicle component 12a relative to the second robot 28 in order to facilitate insertion of the pretensioner 24a, the tongue 24c and the portion of the webbing 24b through the opening 72 of the first vehicle component 12a. For example, the pretensioner 24a may be rotated, then guided through the opening 72 of the first vehicle component 12a before repositioning the first vehicle component 12a in order to guide the tongue 24c through the opening 72. It should be understood that the pretensioner 24a is temporarily located on the pillar 16 of the vehicle body structure 14. That is, in the example illustrated, a bracket 70 (FIG. 4A) may be secured to the pillar 16 and the pretensioner 24a may be removably coupled to the bracket 70. In this way, the robot 28 may detach the pretensioner 24a from the bracket 70 to guide the pretensioner 24a through the opening 72 of the first vehicle component 12a as described above. It should also be understood that the tongue 24c is temporarily retained in a set position on the webbing 24b during the process using a retention feature such as an elastic material, a clip or any other suitable retention feature. The retention feature may be removed from the tongue 24c once the vehicle component 12 is coupled to the pillar 16, thereby allowing the tongue to move along the webbing 24b.

At 216, the control algorithm, using the controller 30, instructs the robot 26 to couple the first vehicle component 12a to the vehicle pillar 16 of the vehicle body structure 14 (FIG. 4E). In the example illustrated, the first vehicle component 12a is coupled to an upper portion of the vehicle pillar 16 by snap fit, fasteners, or any other suitable attachment method. In some forms, the first vehicle component 12a may be coupled to a middle or another location of the vehicle pillar 16.

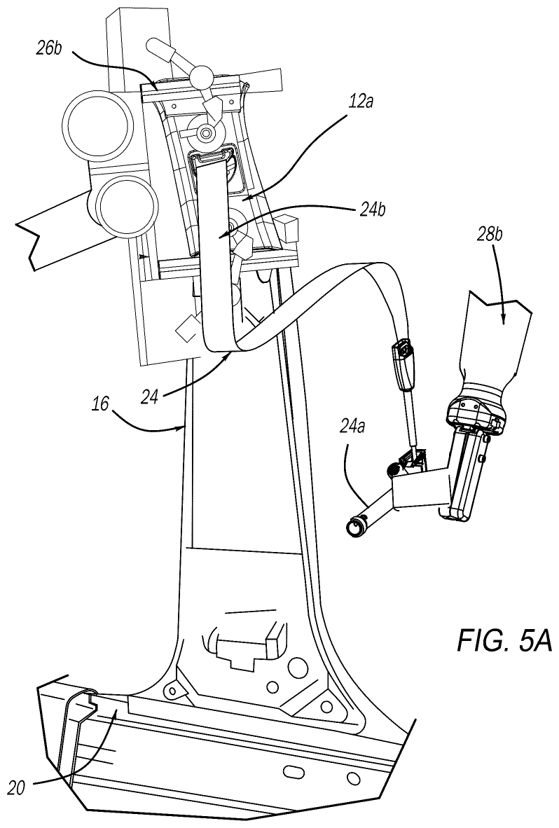

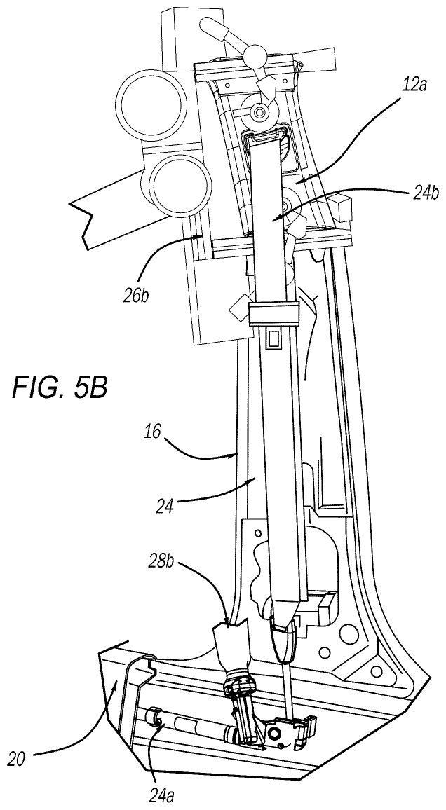

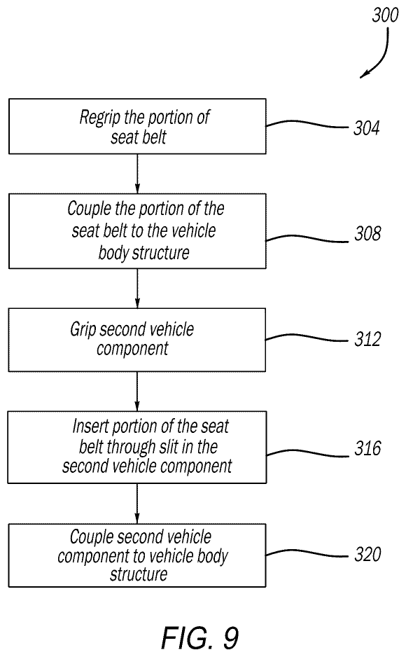

Referring to FIGS. 5A, 5B, 6A-6D and 9, an example control algorithm 300 for assembling a trim panel or second vehicle component 12b of the vehicle component 12 into the vehicle 17 is illustrated. The processing may begin once the first vehicle component 12a is coupled to the vehicle pillar 16. At 304, the control algorithm, using the controller 30, instructs the robot 28 to regrip the pretensioner 24a (FIG. 5A). That is, the robot 28 places the pretensioner 24a on a retaining feature of the robot 26 in order to regrip the pretensioner 24a at another location. In one example, the robot 28 initially grips an end portion of the pretensioner 24a before regripping a middle portion of the pretensioner 24a. In some forms, the robot 28 may place the pretensioner 24a at part support (not shown) in order to regrip the pretensioner 24a at another location. At 308, the control algorithm, using the controller 30, instructs the robot 28 to couple the pretensioner 24a to the vehicle body structure 14 (FIG. 5B). That is, the robot 28 may couple the pretensioner 24a to a rocker of the vehicle body structure 14 via fasteners (e.g., bolts, screws, rivets). In some forms, another robot (not shown) may assist in coupling the pretensioner 24a to the vehicle body structure 14 or the pretensioner 24a may be manually coupled to the vehicle body structure 14 via the fasteners.

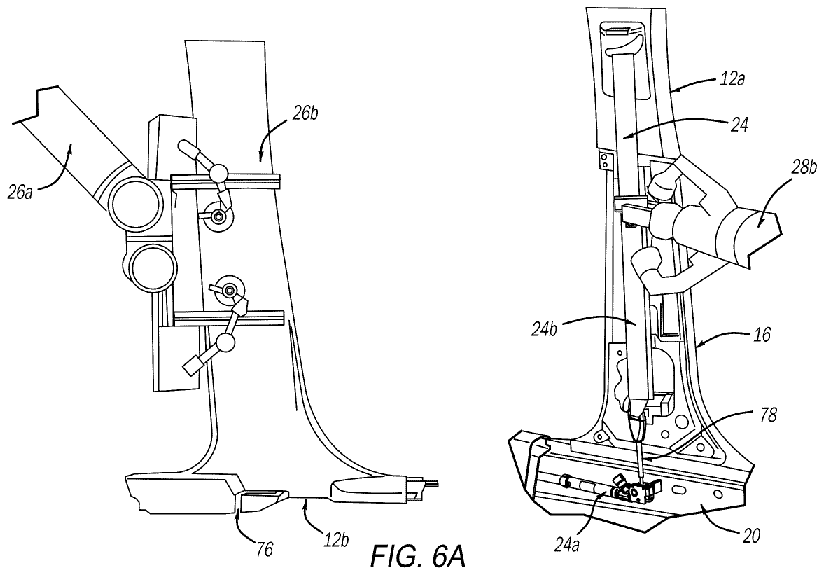

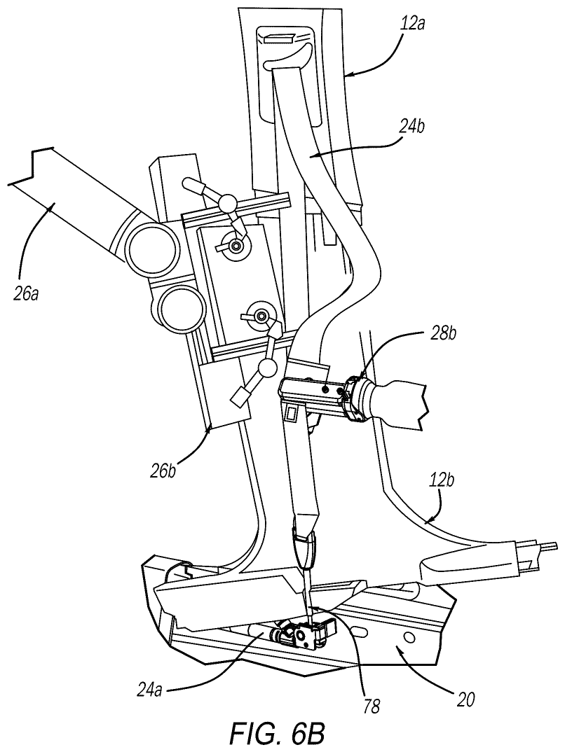

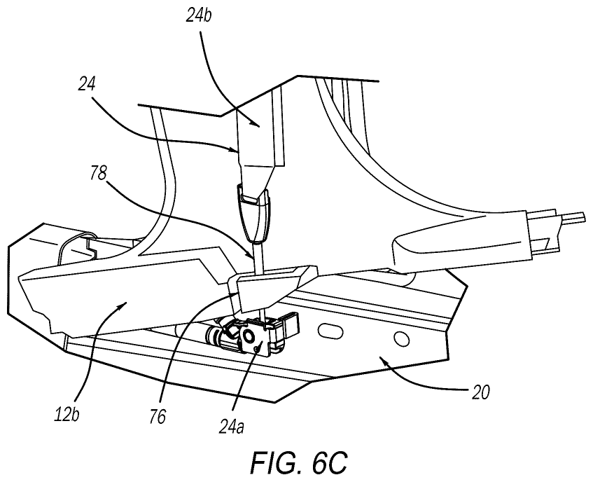

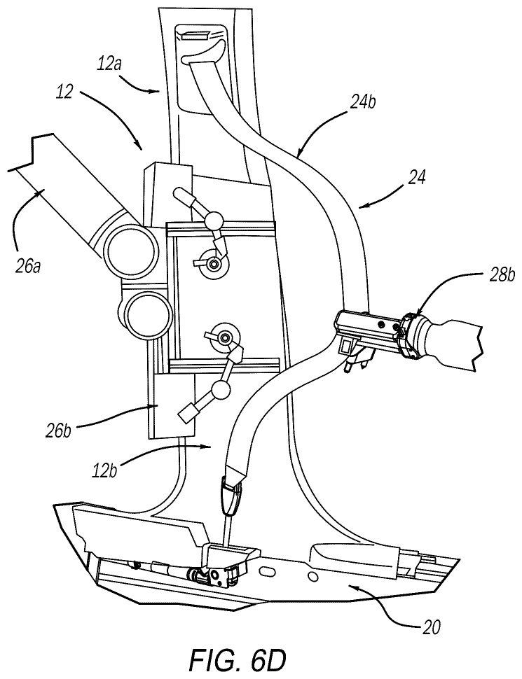

At 312, the control algorithm, using the controller 30, instructs the robot 26 to grip or pick-up the second vehicle component 12b of the vehicle component 12. The second vehicle component 12b may be located at a rack or storage area that inhibits movement of the second vehicle component 12b prior to being picked-up by the robot 26. At 316, the control algorithm, using the controller 30, instructs the robot 26 to move the second vehicle component 12b in a desired pattern such that a portion 78 (e.g., rigid anchor) of the seat belt 24 is received in an opening or slit 76 in the second vehicle component 12b. That is, movement of the second vehicle component 12b guides the portion 78 of the seat belt 24 through the opening in a lower portion of the second vehicle component 12b (FIGS. 6B and 6C). The opening 76 in the lower portion of the second vehicle component 12b may be arcuate or extend in multiple directions such that a first end of the opening 76 opens through a first side of the second vehicle component 12b and a second end of the opening 76 is located between the first side and a second side of the second vehicle component 12b. Once the portion of the seat belt 24 is disposed at or near the second end of the opening 76, the second vehicle component 12b and the seat belt 24 are coupled to each other. It should be understood that as the robot 26 is guiding the portion 78 of the seat belt 24 through the opening 76, the robot 28 may grip or grasp the webbing 24b of the seat belt 24 and pull the webbing 24b away from the second vehicle component 12b. In this way, entanglement between the second vehicle component 12b and the webbing 24b is inhibited.

At 320, the control algorithm, using the controller 30, instructs the robot 26 to couple the second vehicle component 12b to the vehicle pillar 16 of the vehicle body structure 14 (FIG. 6D). In the example illustrated, the second vehicle component 12b is coupled to a lower portion of the vehicle pillar 16 by snap fit, fasteners, or any other suitable attachment method. In some forms, the second vehicle component 12b may be coupled to a middle or another location of the vehicle pillar 16. In some forms, coupling the second vehicle component 12b to the vehicle pillar 16 includes coupling the second vehicle component 12b to the first vehicle component 12a.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A system for assembling a vehicle component to a vehicle body having a seat belt, the system comprising:
at least one robot; and
a controller in communication with the at least one robot, the controller configured to:
instruct the at least one robot to guide a first portion of the seat belt through an opening in a first component of the vehicle component;
instruct the at least one robot to couple the first component to the vehicle body;
instruct the at least one robot to move a second component in a predetermined pattern to guide a second portion of the seat belt into a slit in the second component of the vehicle component; and
instruct the at least one robot to couple the second component to the vehicle body.

2. The system of claim 1, wherein the at least one robot includes a first robot and a second robot, and wherein the first robot couples the first component and the second component to the vehicle body.

3. The system of claim 2, wherein the second robot guides the first portion of the seat belt through the opening in the first component.

4. The system of claim 2, wherein the second robot directs a webbing of the seat belt away from the vehicle body prior to the second component being coupled to the vehicle body.

5. The system of claim 1, wherein the first portion of the seat below is secured to the vehicle body after the first component is coupled to the vehicle body.

6. The system of claim 1, wherein instructing the at least one robot to guide the first portion of the seat belt through the opening in the first component comprises rotating the first portion of the seat belt.

7. A system for assembling a vehicle component to a vehicle body having a seat belt, the system comprising:
a first robot and a second robot; and
a controller in communication with the first robot and the second robot, the controller configured to:
instruct the first robot to pick-up a first component of the vehicle component;
instruct the second robot to guide a first portion of the seat belt through an opening in the first component;
instruct the first robot to couple the first component to the vehicle body;
instruct the first robot to pick-up a second component of the vehicle component;
instruct the first robot to move the second component in a predetermined pattern to guide a second portion of the seat belt into a slit in the second component of the vehicle component; and
instruct the first robot to couple the second component to the vehicle body.

8. The system of claim 7, wherein the vehicle component is a vehicle pillar panel.

9. The system of claim 7, wherein the controller instructs the second robot to direct a webbing of the seat belt away from the vehicle body prior to the second component being coupled to the vehicle body.

10. The system of claim 7, wherein instructing the second robot to guide the first portion of the seat belt through the opening in the first component comprises rotating the first portion of the seat belt.

11. The system of claim 7, wherein the first portion of the seat belt is secured to the vehicle body after the first component is coupled to the vehicle body.

12. The system of claim 7, wherein the controller instructs the first robot to move the first component such that the first component receives the first portion of the seat belt in the opening prior to the second robot guiding the first portion of the seat belt through the opening in the first component.

13. The system of claim 12, wherein the first portion of the seat belt is removably coupled to the vehicle body prior to the first component receiving the first portion of the seat belt in the opening of the first component.

14. The system of claim 7, wherein instructing the second robot to guide the first portion of the seat belt through the opening in the first component further includes guiding a buckle of the seat belt through the opening in the first component.

15. A method for assembling a vehicle component to a vehicle body having a seat belt, the method comprising:
guiding a first portion of the seat belt through an opening in a first component of the vehicle component;
coupling the first component to the vehicle body;
inserting a second portion of the seat belt into a slit in a second component of the vehicle component; and
coupling the second component to the vehicle body.

16. The method of claim 15, wherein the first component and the second component are coupled to the vehicle body using a first robot, and wherein the first portion of the seat belt is guided through the opening using a second robot.

17. The method of claim 15, further comprising directing a webbing of the seat belt away from the vehicle body prior to the second component being coupled to the vehicle body.

18. The method of claim 15, wherein guiding the first portion of the seat belt through the opening in the first component comprises rotating the first portion of the seat belt.

19. The method of claim 15, further comprising securing the first portion of the seat belt to the vehicle body after the first component is coupled to the vehicle body.

20. The method of claim 15, wherein guiding the first portion of the seat belt through the opening in the first component further includes guiding a buckle of the seat belt through the opening in the first component.
